(19) United States
(12) Patent Application Publication
(10) Pub. No.: US 2017/0291252 A1
(43) Pub. Date: Oct. 12, 2017

(54) COIL FOR MAGNETIC-PULSE WELDING OF FLAT PARTS AND RELATED WELDING METHOD

(71) Applicant: ADM28 S.ÀR.L, LUXEMBOURG (LU)

(72) Inventors: GILLES AVRILLAUD, PINSAGUEL (FR); JEAN-PAUL CUQ LELANDAIS, CUGNAUX (FR); SAMUEL FERREIRA, TOULOUSE (FR)

(21) Appl. No.: 15/512,571

(22) PCT Filed: Sep. 23, 2015
(86) PCT No.: PCT/EP2015/071819

§ 371 Date: Mar. 19, 2017

(30) Foreign Application Priority Data
Sep. 23, 2014 (FR) 1458963

(51) Int. Cl. B23K 20/06

(52) U.S. Cl. CPC B23K 20/06; B23K 2201/18

(57) ABSTRACT

A coil to magnetic-pulse weld parts including an active portion, one surface of which is referred to as an active surface, is arrangeable to face one of the parts at an area of overlap between the parts. The active surface has, across the width L_{b} thereof, an angled profile such that the active surface has a non-zero angle in relation to a plane. At least at the working area, the part closest to the active surface extends along the plane, when the parts are positioned at the coil for welding. A related magnetic-pulse welding method is also provided herewith.

### FIELD OF THE INVENTION

The present invention relates to the field of welding, and more particularly the field of magnetic-pulse welding, for assembling parts together permanently. The present invention relates in particular to an enhanced coil embodiment for the welding of flat parts.

### STATE OF THE ART

Magnetic-pulse welding belongs to the field of impact welding methods making it possible to produce a bond between two metal parts by pressure against one another in a zone of overlap. The principle of such a magnetic-pulse welding method is based primarily on the high-velocity impact of the parts by virtue of the electromagnetic forces generated by a coil.

Conventionally, a system for implementing such a magnetic-pulse welding method comprises one or more capacitors linked to a coil to create a brief and intense magnetic field. The capacitor or capacitors is/are used to store a large quantity of electrical energy. The intense magnetic field created is the result of a very rapid discharge of this electrical energy into the coil.

In order to achieve the welding of two parts together with such a method, said two parts are previously superposed on one another, at least over a so-called overlap zone. The coil is positioned at the level of this overlap zone. The part called inner part is that which is positioned close to the coil, without being in contact therewith, and the part called outer part is that which is furthest away from the coil. A very large quantity of electrical energy, previously stored in the capacitor or capacitors, is suddenly discharged into the coil, in the form of a variable current of very high intensity, in a very short time. By way of example, some systems can achieve several hundreds of thousands of amperes in a few microseconds. The current generates a variable magnetic field between the coil and the inner part and induces eddy currents in this inner part. These eddy currents associated with the surrounding magnetic field develop, in the inner part, significant volume forces called Lorentz forces. These forces generate a strong acceleration of the inner part toward the outer part. The speed of collision of the inner part on the outer part can rise to several hundreds of m/s. When certain impact conditions, notably the collision angle and the collision speed, are met, this impact generates, on the one hand, a jet of material which will clean the surface of the two parts, and, on the other hand, a pressure which will bring the atoms of the materials of the two parts against one another such that their natural repelling forces are overcome, thus resulting in a fusion-free metal bond. The wall of the inner part is then not only linked from a metallurgical point of view to the wall of the outer part but has also undergone a remnant deformation.

Such a magnetic-pulse welding method is commonly used for assembling tubular parts, via a so-called annular coil. This method is also used for flat-welding sheet metal over a continuous zone or by spots.

One advantage of such a magnetic-pulse welding method lies in the fact that the assembly of the two parts is performed in the solid state, which makes it possible to address all the known problems in conventional welding involving the fusion of the materials. The energy losses are thus minimal and consequently the parts to be welded do not heat up a lot. The absence of fusion in the parts during the welding thus makes it possible to assemble materials that have a different melting point.

The magnetic-pulse welding method does however present the drawback of requiring strong intensities to weld the parts together. The use of such intensities generates, in the coil, significant temperatures and stresses, that can lead to irreversible damage to the coil, such as cracks or melting of the coil.

Another drawback with this method lies also in the quality of the weld produced. A contact between the two parts is not a guarantee of welding.

For the welding to take place, several parameters have to be taken into account, in particular the collision angle and the collision speed. These two parameters are linked to the initial relative arrangement of the coil and of the two parts to be welded, to the materials of the parts and to the current signal used.

To recap, the collision speed is the radial collision speed between the two parts. The collision point speed, which is tangential to the parts, is also defined. The collision speed and the collision point speed are linked by the collision angle. These collision and collision point speeds change upon the impact. The collision point speed can rise to several thousands of m/s.

The collision angle is defined as the angle between the walls of the two parts upon the collision. The collision angle is dynamic, that is to say that it changes during the collision particularly because the inner part is deformed non-uniformly.

Each pair of materials is defined by a welding window, that is to say a set of parameters (collision angle, collision point speed), making it possible to produce a weld of good quality. Changing one of the parameters can have consequences on the quality of the weld. Among other things, with the collision angle changing during the collision, it is difficult to remain within the welding window.

### SUMMARY OF THE INVENTION

The aim of the present invention is to remedy these drawbacks.

The aim of the present invention is notably to provide an effective solution making it possible to weld so-called flat parts, while ensuring the mechanical strength of the item obtained by such a weld and guaranteeing a healthy weld.

The invention thus relates to a coil for magnetic-pulse welding of parts comprising an active portion of which a surface, called active surface, is intended to be facing one of the parts, in a zone of mutual overlap of the parts. The parts have at least one flat or substantially flat surface.

Flat parts should be understood to be parts that have at least one surface of planar, or substantially planar, form over all or part of their length, at least in their overlap zone.

An active part should be understood to be a zone of the coil where a current is concentrated and circulates, delivered by an electrical energy storage unit, to create a magnetic field at the level of the coil. A thickness of the active zone corresponds substantially to the skin thickness. At high frequency, the current circulates over a reduced thickness corresponding to the skin thickness. The frequency applied in the magnetic-pulse welding is a few tens of kHz, which corresponds for example to a skin thickness of a few millimeters for a coil produced in a steel material.

The flat parts are intended to be arranged one on top of the other, to form, at the superposition thereof, the overlap zone, then to be positioned facing the active surface of the coil, to be welded there in a working zone by the magnetic field generated by the coil. One of the parts, for example the part closest to the active surface of the coil, extends, at least in the working zone, along a given plane XY.

The working zone is the part of the overlap zone situated facing the active surface. Said working zone has a working length L_{wz} corresponding to a maximum welding length between the inner part and the outer part.

The active surface has a given width L_{b}.

The width L_{b} of the active surface is dimensioned so as to allow the production of a weld of predefined length between said parts. This predefined length is the welding length. Preferably, the width of the active surface is at least equal to the welding length.

According to the invention, the active surface of the coil has, over its width L_{b}, an inclined profile such that said active surface is intended to exhibit a non-zero angle relative to the plane, defined by the part closest to the active surface of the coil, when the parts are arranged at the level of the coil and immobilized in position by fixing means for the welding.

Such a form of coil advantageously makes it possible to vary the gap between the active surface of the coil and the part closest to the active surface of the coil, called inner part, which influences the fundamental parameters that are the collision point speed and the collision angle. Such an active surface profile makes it possible, when the inner part is positioned such that its free end is closest to the active surface, to retain a substantially constant collision angle, which makes it possible to remain within the welding window of the pair of materials of the parts to be welded for a longer time. The welding length between the two parts is increased, thus improving the mechanical withstand strength of the assembly.

Another advantage of the coil according to the invention lies in the fact that the maximum stresses, in terms of temperature and plastic deformation, undergone by the coil, and generated by the passage of the current of very high intensity in the coil, are reduced. A change in the profile of the active surface of the coil leads to a change in the distribution of current in the active zone. Indeed, one of the parameters involved is the distance between the active surface of the coil and the inner part. The current density in the active portion decreases as the gap between the active surface of the coil and the inner part increases. Since the current density is in fact inversely proportional to this distance, the profile of the active surface of the coil according to the invention thus makes it possible to increase the distance with the zone of the coil where the current density was highest. In this zone, the stresses are therefore reduced. The life of the coil is significantly increased.

According to preferred implementations, the invention further addresses the following features, implemented separately or in each of their technically feasible combinations.

According to preferred embodiments, the active surface has, over its width L_{b}, an inclined profile over all of the width L_{b}.

According to preferred embodiments, the active surface has, over its width L_{b}, two portions with planar profile linked together by a portion with inclined profile.

According to preferred embodiments, to reduce the plastic deformations in the coil during the welding of the parts, the active portion comprises, on either side of the active surface, a chamfered and/or stepped portion.

According to preferred embodiments, the coil comprises a magnetic field concentrator comprising the active portion. The magnetic field concentrator is positioned between the inner part and an outer surface of the coil. The active portion is then created in said magnetic field concentrator.

The magnetic field concentrator is advantageously an interchangeable part, and makes it possible to retain one and the same coil for several applications (change of dimensions of the parts, etc.).

The coil, according to at least one of its embodiments, forms, with the parts, when the latter are in position at the level of the coil, a welding set. The two parts are preferably arranged one on top of the other to form, at the superposition thereof, the overlap zone. The two parts are facing the active surface of the coil, preferably the part closest to the active surface of the coil extending, at least in the working zone, along the plane XY. The active surface has a width L_{b} at least equal to the width L_{wz}.

The invention also relates to a method for magnetic-pulse welding of two parts. The method comprises the steps of:
arranging the parts relative to one another to form a working zone, facing the active surface of a coil according to one of its embodiments, such that a free end of the inner part is closest to the active surface,
subjecting the working zone to a magnetic field such that a pressure is exerted on a so-called outer wall, of one of the parts and presses it closely against a so-called outer wall of the other part to provoke the permanent bonding thereof; this step is called welding step.

The two flat parts are positioned one on top of the other to form the overlap zone. The two parts are arranged facing the coil such that the working zone situated in the overlap zone is placed facing the active surface. The pressure is exerted on the outer wall of the part closest to the active surface, or inner part, which is pressed against the outer wall of the part furthest away from the active surface, or outer part.

In the welding step, the working zone is subjected to a magnetic field originating from the active portion of the coil such that a pressure is exerted on the outer wall of the part closest to the coil, and presses the opposite outer wall of this part closely against the outer wall of the other part to provoke the permanent bonding thereof.

Thus, when the working zone is subjected to the magnetic field generated by the coil ensuring the pressure-welding, the two parts are pressed closely against one another by the speed imparted on and the deformation of the part closest to the coil toward the other part.

Such a method makes it possible to maintain, in the welding step, a collision angle between the two parts that is substantially constant, which makes it possible to remain within the welding window of the pair of materials forming the parts to be welded. Thus, the weld produced is improved and its length is increased.

Such a method also makes it possible to improve the withstand strength of the coil to the thermal stresses and plastic deformations during the welding step.

### DESCRIPTION OF THE FIGURES

The invention will be better understood on reading the following description given with reference to the attached drawings:

FIG. 1 schematically represents a perspective view of a flat coil for magnetic-pulse welding, according to a first example of embodiment, and the parts to be welded facing one another, represented by dotted lines,

FIG. 2 represents a transverse cross-section of the coil of FIG. 1 along the line AA, illustrating the profile of the active surface of said coil,

FIG. 3 schematically represents a plan view of a flat coil for magnetic-pulse welding, according to a second example of embodiment,

FIG. 4 illustrates a comparison between the welding distances obtained by a coil of the prior art and a coil according to an embodiment of the invention, for a same pair of materials in the associated welding window.

### DETAILED DESCRIPTION OF AN EMBODIMENT OF THE INVENTION

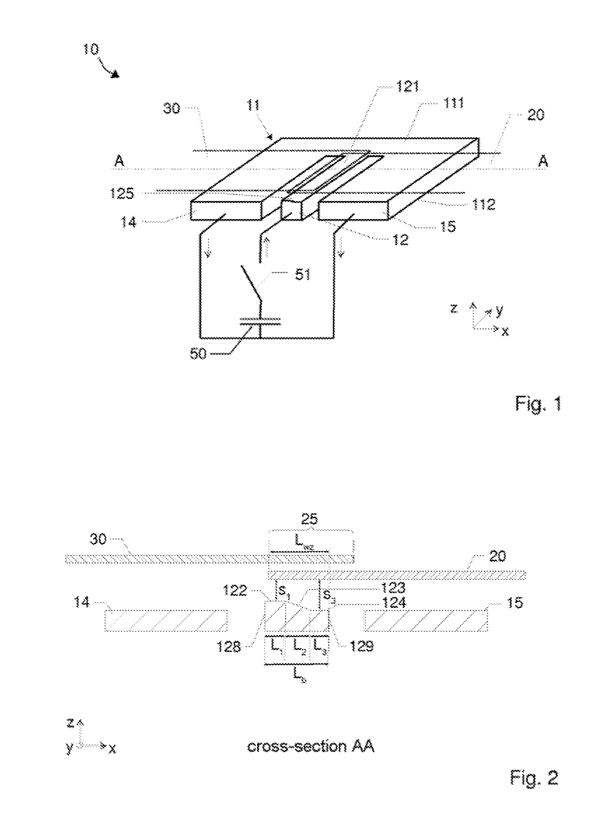

FIGS. 1 and 2 illustrate a coil 10 for the magnetic-pulse welding of two parts 20, 30, according to a first embodiment. The two parts 20, 30 are produced in a metal material.

Such a coil 10 forms an integral part of a magnetic-pulse welding device which further comprises a storage unit 50 and one or more switches 51.

The storage unit 50 is configured and intended to store a high energy, for example of the order of a few tens of kilojoules (kJ).

In a preferred example of embodiment, the storage unit is a battery of discharge capacitors.

The coil is, for its part, configured and intended to create a magnetic field concentrated in a delimited space, described later.

The two parts, called inner part 20 and outer part 30, are intended to be arranged one on top of the other, to form, at the superposition thereof, a so-called overlap zone 25, then to be welded in all or part of said overlap zone by the coil 10. The two parts 20, 30 are positioned one on top of the other substantially parallel, at least in an overlap zone.

Preferably, the overlap zone 25 is situated at an end of at least one part, for example an end of the inner part 20.

The coil and the two parts form, when said two parts are in position at the level of the coil, a welding set.

In an embodiment not represented, when the outer part 20 is produced in a material exhibiting a very low electrical conductivity, such as, for example, a part produced in steel, an intermediate part, called pusher, is positioned against an outer wall of the outer part. This intermediate part exhibits a good electrical conductivity.

In the embodiment described, the coil 10, generally called flat coil, comprises a body 11 in the form of a E laid flat.

The body has a central branch 12 and two lateral branches 14, 15, on either side of the central branch, each separated from said central branch by a slit.

The body 11 has a first face, called top face 111, and a second face, called bottom face 112, opposite said first lateral face.

The body 11 is produced in a material exhibiting specific characteristics in terms, on the one hand, of mechanical resistance to plastic deformation and, on the other hand, of high electrical conductivity to have a current of very high intensity, of the order of a few hundreds of thousands of amperes, circulate therein.

In a preferred example of embodiment, the material of the body is made of steel, preferably, a high strength steel.

The lateral branches 14, 15 preferentially comprise through orifices (not represented) for the passage of fixing means (not represented) configured to fix the coil to a base (not represented) linked to the energy storage unit 50 and to the switch or switches 51.

When the switch or switches 51 is/are closed, the lateral branches 14, 15 and the central branch 12 of the coil 10 are linked to the storage unit 50, and a current of high intensity circulates in the coil 10 producing a magnetic field.

The coil is designed for the density of the current in a zone of the coil to be sufficient to satisfy the welding conditions. This zone is called active portion 125. It is for example described in the document WO 2012/103873.

In the case of a flat coil as described in this embodiment, the current circulates through the coil, by penetrating into the central branch 12 and emerging in the two lateral branches 14, 15, as illustrated by the arrows in FIG. 1. This current is concentrated, in the active portion 125, situated in the central branch 12, on a layer delimited by an active surface 121, at the level of the first face 111, and with a thickness corresponding to the skin thickness.

In the nonlimiting example of a coil produced in steel, the skin thickness is of the order of a few millimeters for a frequency of a few tens of kHz. The current generates, in a space delimited between the overlap zone 25 and the active surface 121, called operational zone, a concentrated magnetic field.

The two parts 20, 30 are advantageously positioned at the level of the coil such that all or part of the overlap zone 25 is facing the active surface 121. The inner part 20 is the part closest to the active portion 125, the one facing the active surface 121.

The overlap zone 25 facing the active surface 121 is called working zone. Said working zone has a predefined length, called working length L_{wz}. This working length L_{wz} corresponds to a maximum welding length between the inner part and the outer part. In practice, the welding length is substantially less than this working length.

The part extends in a plane XY of a trihedron XYZ, substantially parallel to the top face of the coil.

The active surface 121 of the coil has a width L_{b} dimensioned so as to be at least equal to the working length L_{wz} of the overlap zone 25.

The active surface 121 has, over its width L_{b}, an inclined profile, that is to say that the active surface is not parallel to the plane XY of the inner part 20, in the working zone.

In other words, the operational zone has a section which decreases progressively, along the width L_{b}.

In one embodiment, the operational zone has a section of monotonically decreasing transverse cross-section along the width L_{b}, in a direction starting from a first edge 128 to a second edge 129 of the central branch 12.

In a preferred embodiment, the active surface 121 has, over its width L_{b}:
a first portion 122, of width L₁, with planar profile, that is to say that the active surface is parallel to the plane XY of the inner part 20,
a second portion 123, of width L₂, with inclined profile, that is to say that the active surface is not parallel to the plane XY of the inner part 20, in the overlap zone 25,
a third portion 124, of width L₃, with planar profile, that is to say that the active surface is parallel to the plane XY of the inner part 20.

In other words, the operational zone has, over its width L_{b}, a cross section formed by a succession of three sections, in a direction starting from the first edge 128 to the second edge 129 of the central branch 12:
a first section, of width L₁, having a constant transverse cross-section S₁,
a second section, of width L₂, having a monotonically decreasing transverse cross-section,
a third section, of width L₃, having a constant transverse cross-section S₃.

In other words, the operational zone has a transverse cross-section S₁, in the first section, less than a transverse cross-section S₃, in the third section.

The second section is defined by a slope of angle β.

Since the transverse cross-section S₁ of the first section is the closest section to the part, the level of the intensity of the current circulating in the coil will be higher in said first section. In effect, the magnetic field lines are closer together and the magnetic pressure is greater. Thus, the portion of the inner part 20 situated in this first section will have a stronger acceleration in the welding method described later.

On the other hand, since the transverse cross-section S₃ of the third section is greatest, the current density circulating in the coil will be less high in the first section, which will reduce the magnetic pressure in said first section. Furthermore, the coil is less stressed mechanically and thermally in this first section.

Such an active surface profile advantageously makes it possible to use a storage unit delivering a lower energy to the coil, which improves the thermal and structural withstand strength of said coil. Such a storage unit delivering a lower energy also offers a financial benefit.

Such an active surface profile also makes it possible to limit the stresses of the coil at the level of the first portion which makes it possible to increase the life of the coil.

Such an active surface profile also advantageously makes it possible to modify the space between the coil 10 and the inner part 20, which has an impact on the fundamental parameters that are the collision point speed and the collision angle. Such a profile makes it possible, when the inner part 20 is positioned such that its free end is situated at the level of the first section, in the smallest transverse cross-section of the working zone, to keep the fundamental parameters within the weldability window of the material forming the outer part for a longer time. The quality and the effectiveness of the weld between the inner part 20 and the outer part 30 are thus improved.

In a preferred embodiment, the width L₁ of the first section is less than the width L₃ of the third section.

In a preferred example of embodiment, the width L₁ is equivalent to 10% of the width L_{b} of the active surface 121, the width L₃ is equivalent to 30% of the width L_{b} of the active surface 121 and the slope of the second section exhibits an angle β of 15°.

A reduced width L₁ and a slope of pronounced angle β transfers the stresses to the third section.

In another embodiment, when a pusher is used, the width L₁ of the first section is equivalent to the width L₃ of the third section.

In a preferred example of such an embodiment, for a coil produced in steel, the width L₃ and the width L₁ are equivalent to 20% of the width L_{b} of the active surface 121 and the slope of the second section exhibits an angle β of 10°.

In an embodiment not illustrated, to further significantly reduce the plastic deformations of the coil during welding, and consequently reduce the stresses of the coil at the level of the active surface 121, the active portion 125 comprises, on either side of the first 128 and second 129 edges of the central branch 12, a chamfered portion.

In another embodiment, to eliminate the effects of spiking and/or pinching of the magnetic field lines, the central branch comprises, on either side of the first 128 and second 129 edges, a rounded peripheral outline. Thus, the current density is better distributed, which avoids a concentration of stresses and also a temperature spike.

An example of a welding method based on such a coil is now described.

To magnetic-pulse weld two parts together, the method comprises a first step of positioning, in the coil, of the two parts to be welded at the level.

The two parts are positioned one on top of the other to form the overlap zone, at the point where the weld is desired.

The two parts are arranged on the coil 10 such that the working zone is placed facing the active surface 121.

The two flat parts are held, in proximity to the active surface, substantially parallel to one another, at least in the overlap zone, along the plane XY defined by the inner part 20 by fixing means (not represented in the figures).

In a preferred example of implementation, the inner part 20 is positioned such that its end is placed in the smallest transverse cross-section of the working zone, that is to say at the level of the first section.

The method then comprises a magnetic-pulse welding step.

The working zone is subjected to a magnetic field originating from the active portion of the coil such that a pressure is exerted on an outer wall of the inner part, or on an outer wall of the pusher when said pusher is necessary, and presses it closely against an outer wall of the inner part to provoke the permanent bonding thereof.

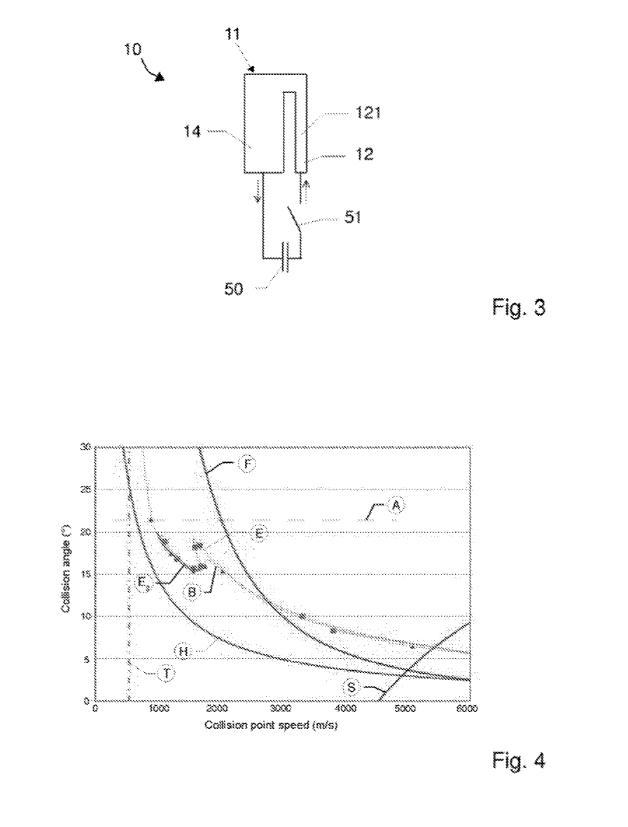

FIG. 3 illustrates another flat coil embodiment. The coil comprises a body 11 in the form of a U laid flat.

The body has two lateral branches 12, 14 separated by a central slit.

When the switch or switches 51 is/are closed, the lateral branches 12, 14 of the coil 10 are linked to the storage unit 50, and a current of high intensity circulates in the coil 10, by penetrating into the lateral branch 12 and by emerging in the lateral branch 14, as illustrated by the arrows in FIG. 3, and producing a magnetic field.

The current is concentrated, in the active portion 125, situated in the branch 12, on a layer delimited by the active surface 121, and of a thickness corresponding to the skin thickness.

The two parts 20, 30 are advantageously positioned at the level of the coil such that the overlap zone 25 is facing the active surface 121.

The present invention is not limited to a flat coil in the form of an E laid flat or a U laid flat. The coil can, to be shaped to the form of the parts to be welded, have different forms.

For example, for flat parts that are desired to be welded by a weld in the form of an S, the coil has an active surface in the form of an S, which will be positioned facing the overlap zone of the parts to be welded.

FIG. 4 illustrates the welding distances obtained by a coil of the prior art and a coil according to an embodiment of the invention, for one and the same given pair of materials.

The coil of the prior art and the coil according to an embodiment of the invention have the following identical characteristics:
the active surface has a width L_{b} of 6 mm,
the material is steel,
the distance between the two parts to be welded is 1.7 mm,
the frequency is a few tens of kHz.

The working length L_{wz} is identical to the width L_{b} of the active surface, in other words 6 mm.

The active surface of the coil of the prior art is planar.

The active surface of the coil according to an embodiment of the invention has:
a first portion, of length L₁ equal to 10% of the width L_{b} of the active surface of the coil;
a third portion, of length L₃ equal to 40% of the width L_{b} of the active surface of the coil;
a second section, having a slope of angle β of 10°.

For a given pair of materials for the two parts to be welded, whatever the form of the active portion of the coil, the welding window is determined. This welding window is defined by the subsonic (curve S), hydrodynamic (curve H), fusion (curve F) and transition (curve T) curves. A maximum collision angle limit, at 22°, is also indicated (curve A) in FIG. 4. More comprehensive explanations on the welding window can be found in the document entitled “Explosive welding of aluminum to aluminum: analysis, computations and experiments,” Grignon et al., International Journal of Impact Engineering 30, (2004) p. 1333-1351.

In this welding window, the curve E represents the trend of the pair (collision angle, collision point speed) for a coil of the prior art. The part in bold E_{g} of the curve E indicates the distance welded (almost four triangles representing 4 mm of welding). Over this welded distance, the collision angle varies enormously, between 15 and 20°, potentially being reflected in the quality of the weld.

The curve B represents the trend of the pair (collision angle, collision point speed) for a coil according to the selected embodiment of the invention. Such a coil makes it possible to weld a zone over a distance of 6 mm (6 squares). Furthermore, it can be seen that, over most of this distance, the collision angle is maintained almost constant, between 16° and 18°.

The above description clearly illustrates that, by its various characteristics and the advantages thereof, the present invention achieves the objectives set. In particular, it provides a coil and a related magnetic-pulse welding method suited to the welding of parts made of material with low thermal conductivity. It advantageously offers a profile in the active portion such that the thermal and mechanical stresses applied to the coil during the welding are significantly reduced, improving the life of the coil. Such a form of coil also offers an improvement to the weld between the parts to be welded.

1-6. (canceled)

7. A coil to magnetic-pulse weld parts, comprising an active portion, of which an active surface is arrangeable to face one of the two parts, in a working zone of an overlap zone of the two parts, wherein the active surface has, over its width, an inclined profile such that the active surface exhibits a non-zero angle relative to a plane along which extends, at least in the working zone, a part closest to the active surface when the two parts are placed in the coil for magnetic-pulse welding.

8. The coil as claimed in claim 7, wherein the active surface comprises, over its width, two portions, each with a planar profile, linked together by a portion with an inclined profile.

9. The coil as claimed in claim 7, wherein the active portion comprises, on either side of the active surface, at least one of a chamfered and stepped portion.

10. The coil as claimed in claim 7, further comprising a magnetic field concentrator comprising the active portion.

11. A welding set comprising the coil as claimed in claim 7 and the two parts facing the active surface of the coil.

12. The welding set as claimed in claim 11, wherein the two parts are arranged one on top of other to form the overlap zone at the superposition thereof.

13. The welding set as claimed in claim 11, wherein a part closest to the active surface of the coil extends, at least in the working zone, along the plane.

14. A method for magnetic-pulse welding of two parts, comprising the steps of:
arranging the two parts relative to one another to form a working zone, the two parts faces an active surface of a coil for magnetic-pulse welding the two parts such that a free end of a part closest to the active surface is closest to the active surface, wherein the active surface has, over its width, an inclined profile such that the active surface exhibits a non-zero angle relative to a plane XY; and
subjecting the working zone to a magnetic field such that a pressure is exerted on a wall of one of the parts to press it against a wall of other part to provoke a permanent bonding thereof.
